(19) United States
(12) Patent Application Publication
(10) Pub. No.: US 2023/0203314 A1
(43) Pub. Date: Jun. 29, 2023

(54) DYE FOR MATERIAL WITH AMIDE FUNCTIONAL GROUPS AND DYEING METHOD OF USING THE SAME

(71) Applicant: Industrial Technology Research Institute, Hsinchu (TW)

(72) Inventors: Jie-Len Huang, Hsinchu City (TW); Pei-Ching Chang, Hsinchu County (TW); Chang-Jung Chang, Taoyuan City (TW); Jhong-De Lin, Kaohsiung City (TW); Ya-Lin Lin, Hsinchu City (TW); Hung-Yu Liao, Taoyuan City (TW); Hsiang-Yuan Chu, Hsinchu City (TW)

(73) Assignee: Industrial Technology Research Institute, Hsinchu (TW)

(21) Appl. No.: 17/564,239

(22) Filed: Dec. 29, 2021

(51) Int. Cl. C09B 69/10

(52) U.S. Cl. CPC C09B 69/104

(57) ABSTRACT

A dye for a material with amide functional groups and a dyeing method of using the same are provided. The dye includes a compound represented by Formula (I) and a solvent. Based on the total weight of the dye of 100 wt %, a content of the compound represented by Formula (I) is 40 wt % to 95 wt %.

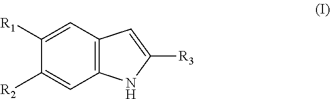

In Chemical Formula (I), R₁, R₂ and R₃ are each independently H, —OH or —COOH, wherein at least one of R₁, R₂ and R₃ is —OH or —COOH.

### TECHNICAL FIELD

The disclosure relates to a dye and a dyeing method of using the same, and more particularly, to a dye for a material with amide functional groups and a dyeing method of using the same.

### BACKGROUND

Polyamide-containing materials (such as nylon materials) are mostly dyed with acid dyes. The acid dyes form strong bonds with the polyamide-containing materials through ionic bonds, hydrogen bonds, and Van der Waals force for dyeing. Most of the acid dyes are azo dyes (—N═N—) containing sulfonic acid groups (—SO₃H), and the petrochemicals for the production of the azo dyes (such as aniline or its derivatives) is suspected of being carcinogenic and toxic, and will be banned in the future.

Therefore, it is an issue that researchers are eager to develop dyestuffs that do not use petrochemicals, such as aniline, and may be used to dye the polyamide-containing materials while reducing the risk of harm to the environment and human health.

### SUMMARY

The disclosure provides a dye that does not use aniline as a raw material and is effective on a material with amide functional groups, which is not only conducive to a low-carbon manufacturing process, but also has commercial value.

The disclosure provides a dyeing method, which may be applied to a material with amide functional groups, and may enable the dyed material to have the excellent color strength.

The disclosure provides a dye for dyeing a material with amide functional groups, and the dye includes:

a compound represented by Formula (I), and

a solvent.

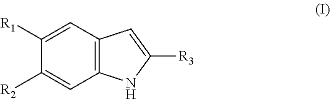

In the Formula (I), R₁, R₂ and R₃ are each independently H, —OH, or —COOH,

in which at least one of R₁, R₂ and R₃ is —OH or —COOH, and

based on a total weight of the dye of 100 wt %, a content of the compound represented by the Formula (I) is 40 wt % to 95 wt %.

The disclosure provides a dyeing method, which includes contacting a material with amide functional groups by a dye solution to perform a dyeing step. The dye solution includes a dye containing a compound represented by Formula (I).

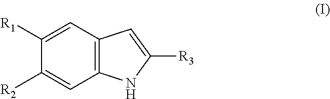

In the Formula (I), R₁, R₂ and R₃ are each independently H, —OH, or —COOH,

in which at least one of R₁, R₂ and R₃ is —OH or —COOH, and

based on a total weight of the dye of 100 wt %, a content of the compound represented by the Formula (I) is 40 wt % to 95 wt %.

Based on the above, the dye provided by the disclosure may be used for dyeing of the polyamide material, and does not use aniline, which is suspected of being toxic, as the raw material, which is not only conducive to the low-carbon manufacturing process, but also may effectively reduce the risk of harm to the environment and the human health.

### DETAILED DESCRIPTION

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

The term “about”, “approximately”, “essentially” or “substantially” used herein includes the value and an average value within an acceptable deviation range of specific values determined by a person of ordinary skill in the art, taking into account discussed measurements and a specific number of measurement-related errors (i.e., limitations of a measuring system). For example, the term “about” may mean being within one or more standard deviations of the value, or within, for example, ±30%,±20%, ±10%, and ±5%. Moreover, the term “about”, “approximately”, “essentially” or “substantially” used herein may mean selecting a more acceptable deviation range or standard deviations according to measurement properties or other properties, without applying a single standard deviation to all properties.

In order to provide a dye that does not use aniline as a raw material, and may be used for a polyimide material and is conducive to a low-carbon manufacturing process, the disclosure provides a dye including an indole structure and a dyeing method of using the same, which may achieve the above advantages. Hereinafter, embodiments are described as examples by which the disclosure may be actually implemented.

In this embodiment, the dye in the disclosure is a dye for dyeing a material with amide functional groups. In an embodiment, the material with amide functional groups is, for example, nylon, an artificial leather with amide functional groups, or a combination thereof. In an embodiment, the artificial leather with amide functional groups is, for example, polyurethane (PU) containing amide functional groups.

In this embodiment, the dye including the indole structure includes a compound represented by the following Formula (I) and a solvent.

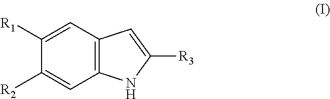

In Formula (I), R₁, R₂, and R₃ are each independently H, —OH, or —COOH.

At least one of R₁, R₂, and R₃ is —OH or —COOH.

In an embodiment, at least one of R₁ and R₂ is —OH, and R₃ is H or —COOH.

In an embodiment, the compound represented by the Formula (I) may include 5,6-dihydroxyindole (DHI), 5,6-dihydroxyindole-2-carboxylic acid (DHICA), or a combination thereof.

Structural formulas of 5,6-dihydroxyindole (DHI) and 5,6-dihydroxyindole-2-carboxylic acid (DHICA) are respectively shown below.

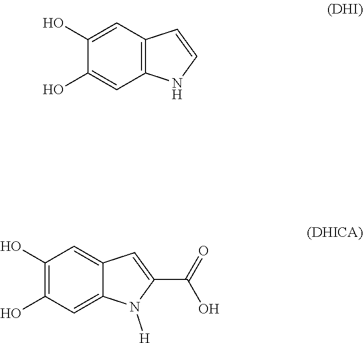 [SMILES: Oc1cc2cc[nH]c2cc1O ; O=C(O)c1cc2cc(O)c(O)cc2[nH]1]

In this embodiment, the compound represented by the Formula (I) may be obtained by chemical synthesis or biosynthesis. In an embodiment, the biosynthesis is, for example, a fermentation product of a microorganism. It should be noted that the compound represented by the Formula (I) in the disclosure does not need to use aniline or an aniline derivative as a synthetic raw material. Therefore, a risk of harm to an environment and human health may be reduced.

In an embodiment, based on a total weight of the dye of 100 wt %, a content of the compound represented by the Formula (I) may be about 40 wt % to 95 wt %, for example, about 55 wt % to 90 wt %, 60 wt % to 85 wt %, 52 wt %, 58 wt %, 66 wt %, 73 wt %, 76 wt %, 87 wt %, 92 wt %, etc., but the disclosure is not limited thereto.

In an embodiment, the dye in the disclosure includes the compound represented by the Formula (I), but the disclosure is not limited thereto. In another embodiment, the dye in the disclosure includes more than one, for example, two or more, compounds represented by the Formula (I).

In an embodiment, the compound represented by the Formula (I) includes 5,6-dihydroxyindole (DHI) and 5,6-dihydroxyindole-2-carboxylic acid (DHICA), and a weight ratio of 5,6-dihydroxyindole to 5,6-dihydroxyindole-2-carboxylic acid may be about 1:15 to 15:1, for example, about 1:12 to 12:1, 1:10 to 10:1, 1:8 to 8:1, 1:5 to 5:1, 1:3 to 3:1, 1:2 to 2:1, 1:9, 5:5, 7:3, 9:1, etc., but the disclosure is not limited thereto. In an embodiment, a user may choose different weight ratios of DHI to DHICA to formulate the dye according to a desired hue of the user (e.g., brownish or blackish), and the dye is applied to the dyeing of the material with amide functional groups. In an embodiment, the material with amide functional groups is, for example, nylon, the artificial leather, or a combination thereof, but the disclosure is not limited thereto.

In this embodiment, the solvent of the dye may include water, for example, distilled water, deionized water, ultrapure water, or a combination thereof, but the disclosure is not limited thereto. Under the premise that there is no risk of harm to the environment and human beings, the user may choose the suitable solvent to formulate the dye according to the actual requirements.

In an embodiment, the hue produced by the dye in the disclosure is black, brown, or a mixture of the two. In an embodiment, the dye in the disclosure includes 5,6-dihydroxyindole (DHI), and the hue produced by the dye is black. In another embodiment, the dye in the disclosure includes 5,6-dihydroxyindole-2-carboxylic acid (DHICA), and the hue produced by the dye is brown. In an embodiment, the dye in the disclosure include 5,6-dihydroxyindole (DHI) and 5,6-dihydroxyindole-2-carboxylic acid (DHICA), and the hue produced by the dye is black, brown, or the mixture of the two. Specifically, the hue may be controlled by adjusting a ratio of 5,6-dihydroxyindole (DHI) to 5,6-dihydroxyindole-2-carboxylic acid (DHICA). In more detail, the higher a content of 5,6-dihydroxyindole-2-carboxylic acid (DHICA) is, the more brownish the hue is, while the higher a content of 5,6-dihydroxyindole (DHI) is, the more blackish the hue is.

In an embodiment, the dye performs dyeing in an acidic environment. In an embodiment, a pH value of the dye in the disclosure may be 3.5 to 6.5, for example, 3.8 to 6.3, 4.0 to 6.0, 4.2 to 5.8, 4.5 to 5.5, etc., but the disclosure is not limited thereto. In an embodiment, the pH value of the dye in the disclosure may be 4 to 6. The dye in a range of the above pH values may ensure that the dyed material has excellent color strength (K/S), color fastness to washing, color fastness to water, and color fastness to dry and wet crocking. In an embodiment, the dye in the disclosure may further include a pH regulator, and the pH value of the dye in the disclosure may be adjusted by the pH regulator. In an embodiment, the pH regulator is, for example, an organic acid, an organic base, an inorganic acid, an inorganic base, or a combination thereof.

In addition, the disclosure also provides the dyeing method of using the above dye. In this embodiment, a dye solution is used to contact the material with amide functional groups to perform a dyeing step. In this embodiment, the dye solution includes the dye including the compound represented by the Formula (I), but the disclosure is not limited thereto. In this embodiment, when the material with amide functional groups is in an acidic environment, —NH₂ forms —NH3 and has a positive charge, while the functional groups (such as hydroxyl groups or carboxyl groups) on the dye in the disclosure have a negative charge, which is bonded to the material with amide functional groups through ionic bonds, thereby dyeing the material. In an embodiment, the dye solution may further include at least one other dye, such as a commercial dye.

In this embodiment, a concentration of the dye in the dye solution in the disclosure may be 1% on weight of the fabric (o.w.f.) to 25% on weight of the fabric, for example, 2% to 20% on weight of the fabric, 5% to 18% on weight of the fabric, 8% to 15% on weight of the fabric, 10% on weight of the fabric, 12.5% on weight of the fabric, etc., but the disclosure is not limited thereto. The dye of the disclosure in the above concentration range may ensure that the dyed material has excellent color strength (K/S), color fastness to washing, color fastness to water, and color fastness to dry and wet crocking.

In general, K/S value of >3 for dye is the minimum standard for commercial application during the dyeing and finishing process. The depth of color is related to the amount used as well as the coloring efficiency of the dye. When the concentration of the dye in the used dye solution is less than 1% o.w.f., the dyeing result will be too light (that is, the K/S value is less than 3), and the dyeing effect will be poor since a colored component of the dye is too low. Conversely, if the excessive dye is used (that is, more than 25% on weight of the fabric), the excessive dye contained in a discharged residual solution after dyeing may result in increased costs of wastewater treatment and risks of environmental pollution.

In this embodiment, a reaction temperature of the dyeing step may be 80° C. to 130° C., for example, 85° C. to 125° C., 90° C. to 120° C., 95° C. to 115° C., 82° C., 87° C., 93° C., 98° C., 105° C., 112° C., 122° C., etc., but the disclosure is not limited thereto. In this embodiment, a reaction time of the dyeing step may be 30 minutes to 60 minutes, for example, 35 minutes to 55 minutes, 40 minutes to 50 minutes, 32 minutes, 38 minutes, 40 minutes, 45 minutes, 50 minutes, 58 minutes, etc., but the disclosure is not limited thereto. In this embodiment, a reaction pH value of the dyeing step may be 3.5 to 6.5, for example, 3.8 to 6.3, 4.0 to 6.0, 4.2 to 5.8, 4.5 to 5.5, etc., but the disclosure is not limited thereto. The dye in the disclosure performs dyeing under the above reaction conditions, which may ensure that the dyed material has excellent color strength (K/S), color fastness to washing, color fastness to water, and color fastness to dry and wet crocking.

In this embodiment, after the dyeing step is performed to dye the material with amide functional groups, a washing process may be further performed on the dyed material with amide functional groups to remove the redundant dye. For the washing process, water, a lotion, or the like may be used.

In addition, in this embodiment, regardless of whether the washing process is performed or not, a drying process is performed on the dyed material with amide functional groups to facilitate the subsequent application. The drying process is, for example, natural air drying, hot air drying, rotary drying, suction drying, etc.

In this embodiment, a test of color fastness to dry and wet crocking (AATCC 8) for the dyed material with amide functional groups is at a grade of 4 to 5. A test of color fastness to water (AATCC 107) for the dyed material with amide functional groups is at a grade of 4 to 5. A test of color fastness to washing (AATCC 61) for the dyed material with amide functional groups is at a grade of 4 to 5. The dyed material with amide functional groups has a L* value of 8 to 60, a a* value of −5 to 15, a b* value of −10 to 25, and a K/S value of 3 to 35. “L*” stands for perceived lightness, where L*=0 indicates the black color, and L*=100 indicates the white color. “a*” and “b*” stand for four unique colors of human vision, which are red, green, blue, and yellow. “a*” is a red/green value. “a*” indicates the green color when it is a negative value, and “a*” indicates the red color when it is a positive value. “b*” is a blue/yellow value. “b*” indicates the blue color when it is a negative value, and “b*” indicates the yellow value when it is a positive value.

Moreover, as mentioned above, the hue of the dyed material with amide functional groups is black, brown, or a mixed color of the two. In addition, by adjusting the ratio of different compounds represented by the Formula (I) in the dye, the hue may be controlled according to the requirements.

By performing the above steps, the dyeing method provided by the embodiment of the disclosure may be completed. It is worth noting that aniline or the aniline derivative is not used as the synthetic raw material for the dye in the disclosure, which may not only reduce the risk of harm to the environmental and the human health, but also meet requirements of the sustainable and low-carbon manufacturing process in the nylon industry. In addition, the dye in the disclosure may effectively dye the material with amide functional groups, and may have dyeing formulas of different colors, which are conducive to the functional nylon market.

Hereinafter, the disclosure is described in more detail with reference to the embodiments. Although the following embodiments are described, the materials used, the amounts and ratios thereof, processing details, and processing procedures, etc. may be appropriately changed without departing from the scope of the disclosure. Therefore, the disclosure should not be construed in a limited way according to the experiments described below.

### Experimental Example 1: Dyeing a Nylon Fabric with Dyestuff Containing DHICA

### Embodiment 1

First, 5,6-dihydroxyindole-2-carboxylic acid (DHICA) of 90 wt % is formulated as a dye. Then, the dye is added to water to be formulated into a dye solution of 2% o.w.f., and a pH value of the dye solution is adjusted to 5. Next, the nylon fabric is immersed in the dye solution, dyed at a reaction temperature of 105° C. and the pH value of 5 for 50 minutes, soaped at 65° C. for 15 minutes, and then washed with clean water and dried, so as to obtain the dyed nylon fabric of Embodiment 1.

### Embodiment 2

Dyeing is performed by a method similar to Embodiment 1, and the only difference is that a concentration of the dye of Embodiment 2 was 5% o.w.f.

### Embodiment 3

Dyeing is performed by the method similar to Embodiment 1, and the only difference is that a concentration of the dye of Embodiment 3 was 10% o.w.f.

### Embodiment 4

Dyeing is performed by the method similar to Embodiment 1, and the only difference is that a concentration of the dye of Embodiment 4 was 15% o.w.f.

### Embodiment 5

Dyeing is performed by the method similar to Embodiment 1, and the only difference is that a concentration of the dye of Embodiment 5 was 20% o.w.f.

### Embodiment 6

Dyeing is performed by the method similar to Embodiment 1, and the only difference is that a concentration of the dye of Embodiment 6 was 25% o.w.f.

After the dyed nylon fabric of Embodiments 1 to 6 are obtained, the measurement of the color strength and the test of the physical properties are performed on the dyed nylon fabric of Embodiments 1 to 6, and results thereof are shown in Table 1 below.

### <Measurement of the Color Strength Value>

A color spectrophotometer (i1 Basic Pro 2) is used to measure the color strength (K/S) value of the dyed nylon fabric of Embodiments 1 to 6, in which the unit thereof is K/S. The substance that absorbs light is mainly the dye. When the concentration of the dye is higher, the absorption intensity is larger, and the scattering strength is smaller. The color strength (K/S) value is calculated by the following formula proposed by the Kubelka-Munk theory.

$$\frac{K}{S} = \frac{{( 1 - R )}^{2}}{2 R}$$

K is an absorption coefficient; S is a scattering coefficient, and R is a reflectance at a maximum absorption wavelength.

Evaluation methods adopted for the test of the physical properties for the dyed nylon fabric are the test of color fastness to washing (AATCC 61), the test of color fastness to water (AATCC 107), and the test of color fastness to dry and wet crocking (AATCC 8).

The test of color fastness to washing (AATCC 61) and the test of color fastness to water (AATCC 107) are the assessments for the degree of discoloration after washing, which are evaluated with five grades. The higher the grade is, the greater the color fastness is.

The test of color fastness to dry and wet crocking (AATCC 8) is an assessment for the degree of discoloration after dry rubbing or wet rubbing, which is evaluated with five grades. The higher the grade is, the greater the color fastness is.

It is worth noting that the test of color fastness to washing (AATCC 61), the test of color fastness to water (AATCC 107), and the test of color fastness to dry and wet crocking are only of commercial value at the grade of 4 or more.

TABLE 1

| | | | | | | color of | color | color | color fastness |
|---|---|---|---|---|---|---|---|---|---|
| | | | | | | the dyed | fastness | fastness | to dry and |
| | % | | | | | nylon | to washing | to water | wet crocking |
| | o.w.f. | L* | a* | b* | K/S | fabric | (AATCC 61) | (AATCC 107) | (AATCC 8) |
| Embodiment | 2 | 52.6 | 5.5 | 14.1 | 4.0 | brown | 4-5 | 4-5 | 4-5 |
| 1 | | | | | | | | | |
| Embodiment | 5 | 49.2 | 6.9 | 14.8 | 4.7 | brown | 4-5 | 4-5 | 4-5 |
| 2 | | | | | | | | | |
| Embodiment | 10 | 45.1 | 6.9 | 15.8 | 7.1 | brown | 4-5 | 4-5 | 4-5 |
| 3 | | | | | | | | | |
| Embodiment | 15 | 38.9 | 6.0 | 13.5 | 9.2 | brown | 4-5 | 4-5 | 4-5 |
| 4 | | | | | | | | | |
| Embodiment | 20 | 41.2 | 8.3 | 16.9 | 9.6 | brown | 4-5 | 4-5 | 4-5 |
| 5 | | | | | | | | | |
| Embodiment | 25 | 34.2 | 6.9 | 13.8 | 13.8 | brown | 4 | 4 | 4 |
| 6 | | | | | | | | | |

According to the above evaluation results, the test of color fastness to washing, the test of color fastness to water, and the test of color fastness to dry and wet crocking for the nylon fabric of Embodiments 1 to 5 after dyed with the dye (DHICA) in the disclosure are all at the grade of 4 to 5, while the test of color fastness to washing, the test of color fastness to water, and the test of color fastness to dry and wet crocking for the nylon fabric of Embodiment 6 are at the grade of 4, which indicates that the nylon fabric dyed with the dye in the disclosure have comprehensive properties such as good color fastness to washing, color fastness to water, and color fastness to dry and wet crocking, and conform to industrial availability. In addition, as the concentration (% o.w.f.) of the dye is higher, the color strength of the dye (i.e. the K/S value) is higher. Furthermore, under dyeing conditions of the disclosure, the colors of the nylon fabric of Embodiments 1 to 6 have the hue of brown.

### Experimental Example 2: Dyeing the Nylon Fabric with a Dye Containing DHI

### Embodiment 7

First, 5,6-dihydroxyindole (DHI) of 90 wt % is formulated as a dye. Then, the dye is added to the water to be formulated into a dye solution of 5% o.w.f., and a pH value of the dye solution is adjusted to 5. Next, the nylon fabric is immersed in the dye solution, dyed at the reaction temperature of 105° C. and the pH value of 5 for 50 minutes, soaped at 65° C. for 15 minutes, and then washed with the clean water and dried, so as to obtain the dyed nylon fabric of Embodiment 7.

After the dyed nylon fabric of Embodiment 7 is obtained, the measurement of the color strength and the test of the physical properties are performed on the dyed nylon fabric of Embodiment 7, and results thereof are shown in Table 2 below.

TABLE 2

| | | | | | | color of | color | color | color fastness |
|---|---|---|---|---|---|---|---|---|---|
| | | | | | | the dyed | fastness | fastness | to dry and |
| | % | | | | | nylon | to washing | to water | wet crocking |
| | o.w.f. | L* | a* | b* | K/S | fabric | (AATCC 61) | (AATCC 107) | (AATCC 8) |
| Embodiment 7 | 5 | 12.3 | 3.7 | 1.4 | 21.3 | black | 4-5 | 4-5 | 4-5 |

According to the above evaluation results, the test of color fastness to washing, the test of color fastness to water, and the test of color fastness to dry and wet crocking for the nylon fabric of Embodiment 7 after dyed with the dye (DHI) in the disclosure are all at the grade of 4 to 5, which indicates that the nylon fabric dyed with the dye in the disclosure has the comprehensive properties such as good color fastness to washing, color fastness to water, and color fastness to dry and wet crocking, and conforms to industrial availability. In addition, under the dyeing conditions of the disclosure, the color of the nylon fabric of Embodiment 7 has the hue of black.

### Experimental Example 3: Dyeing an Artificial Leather with the Dye Containing DHICA

### Embodiment 8

First, 5,6-dihydroxyindole-2-carboxylic acid (DHICA) of 90 wt % is formulated as a dye. Then, the dye is added to the water to be formulated into a dye solution of 2% o.w.f., and a pH value of the dye solution is adjusted to 5. Next, the artificial leather (which is polyurethane with amide functional groups) is immersed in the dye solution, dyed at a reaction temperature of 90° C. and the pH value of 5 for 50 minutes, soaped at 65° C. for 15 minutes, and then washed with the clean water and dried, so as to obtain the dyed artificial leather of Embodiment 8.

### Embodiment 9

Dyeing is performed by a method similar to Embodiment 8, and the only difference is in a polyurethane composition of the artificial leathers of Embodiment 9 and Embodiment 8. In detail, the artificial leathers of Embodiment 9 and Embodiment 8 are synthesized by different manufacturing processes. The artificial leather of Embodiment 8 is formed by polyester fiber and polyurethane, and the artificial leather of Example 9 is formed by polyester microfiber and polyurethane.

After the artificial leathers of Embodiments 8 and 9 are obtained, the measurement of the color strength and the test of the physical properties are performed on the dyed artificial leathers of Embodiments 8 and 9, and results thereof are shown in Table 3 below.

TABLE 3

| | | | | | | | color |
|---|---|---|---|---|---|---|---|
| | | | | | | color of | fastness |
| | | | | | | the dyed | to water |
| | % | | | | | artificial | (AATCC |
| | o.w.f. | L* | a* | b* | K/S | leather | 107) |
| Embodiment | 5 | 59.11 | 2.78 | 12.29 | 8.2 | brown | 4 |
| 8 | | | | | | | |
| Embodiment | 5 | 59.31 | 2.83 | 11.81 | 6.9 | brown | 4 |
| 9 | | | | | | | |

According to the above evaluation results, color fastness to water for the artificial leathers of Embodiments 8 and 9 after dyed with the dye (DHICA) in the disclosure are both at the grade of 4, which indicates that the artificial leathers dyed with the dye in the disclosure have good fastness to water, and conform to industrial availability. In addition, under the dyeing conditions of the disclosure, the colors of the artificial leathers of Embodiments 8 and 9 have the hue of brown.

### Experimental Example 4: Dyeing the Nylon Fabric with the Dye Containing DHI and DHICA

### Embodiment 10

First, 5,6-dihydroxyindole (DHI) and 5,6-dihydroxyindole-2-carboxylic acid (DHICA) of 90 wt % are formulated as a dye, and the weight ratio of DHI to DHICA is 1:9. Then, the dye is added to the water to be formulated into a dye solution of 2% o.w.f., and a pH value of the dye solution is adjusted to 5. Next, the nylon fabric is immersed in the dye solution, dyed at the reaction temperature of 105° C. and the pH value of 5 for 50 minutes, soaped at 65° C. for 15 minutes, and then washed with the clean water and dried, so as to obtain the dyed nylon fabric of Embodiment 10.

### Embodiment 11

Dyeing is performed by a method similar to Embodiment 10, and the only difference is that the weight ratio of DHI to DHICA in Example 11 is 5:5.

### Embodiment 12

Dyeing is performed by the method similar to Embodiment 10, and the only difference is that the weight ratio of DHI to DHICA in Example 12 is 7:3.

### Embodiment 13

Dyeing is performed by the method similar to Embodiment 10, and the only difference is that the weight ratio of DHI to DHICA in Example 13 is 9:1.

After the dyed nylon fabric of Embodiments 10 to 13 are obtained, the measurement of the color strength and the test of the physical properties are performed on the dyed nylon fabric of Embodiments 10 to 13, and results thereof are shown in Table 4 below.

TABLE 4

| | | | | | | | color of | color fastness |
|---|---|---|---|---|---|---|---|---|
| | % | | | | | | the dyed | to water |
| | o.w.f. | DHI:DHICA | L* | a* | b* | K/S | nylon fabric | (AATCC 107) |
| Embodiment | 2 | 1:9 | 52.11 | 8.32 | 20.84 | 4.3 | brownish | 4-5 |
| 10 | | | | | | | black | |
| Embodiment | 2 | 5:5 | 45.84 | 7.16 | 16.09 | 7.2 | brownish | 4-5 |
| 11 | | | | | | | black | |
| Embodiment | 2 | 7:3 | 27.81 | 3.21 | 6.73 | 13.8 | brownish | 4-5 |
| 12 | | | | | | | black | |
| Embodiment | 2 | 9:1 | 18.64 | 2.82 | 1.51 | 19.5 | brownish | 4 |
| 13 | | | | | | | black | |

According to the above evaluation results, the tests of color fastness to water for the nylon fabric of Embodiments 10 to 12 after dyed with the dye (containing DHI and DHICA) in the disclosure are all at the grade of 4 to 5, while the test of color fastness to water for the nylon fabric of Embodiment 13 is at the grade of 4, which indicates that the nylon fabric dyed with the dye in the disclosure have good color fastness to water, and conform to industrial availability. In addition, as the ratio of DHI is higher, the K/S value is higher. Furthermore, under the dyeing conditions of the disclosure, the colors of the nylon fabric of Embodiments 10 to 13 have the hue of brown. More specifically, the higher the ratio of DHI is, the more blackish the hue is (i.e., darkly brownish black), and the higher the ratio of DHICA is, the more brownish the hue is (i.e., lightly brownish black). In other words, the dye in the disclosure may control the hue by adjusting the ratio between DHI and DHICA.

### Experimental Example 5: Dyeing the Nylon Fabric at Different pH Values

### Embodiment 14

First, 5,6-dihydroxyindole (DHI) and 5,6-dihydroxyindole-2-carboxylic acid (DHICA) of 90 wt % are formulated as a dye, and the weight ratio of DHI to DHICA is 5:5. Then, the dye is added to the water to be formulated into a dye solution of 1% o.w.f., and a pH value of the dye solution is adjusted to 4.5. Next, the nylon fabric is immersed in the dye solution, dyed at the reaction temperature of 105° C. and the pH value of 4.5 for 50 minutes, soaped at 65° C. for 15 minutes, and then washed with the clean water and dried, so as to obtain the dyed nylon fabric of Embodiment 14.

### Embodiment 15

Dyeing is performed by a method similar to Embodiment 14, and the only difference is that the dye of Embodiment 15 has the pH value of 5.

### Embodiment 16

Dyeing is performed by the method similar to Embodiment 14, and the only difference is that the dye of Embodiment 16 has a pH value of 6.

### Comparative Example 1

Dyeing is performed by the method similar to Embodiment 14, and the only difference is that the dye of Comparative Example 1 has a pH value of 7.

### Comparative Example 2

Dyeing is performed by the method similar to Embodiment 14, and the only difference is that the dye of Comparative Example 2 has a pH value of 8.

### Comparative Example 3

Dyeing is performed by the method similar to Embodiment 14, and the only difference is that the dye of Comparative Example 3 has a pH value of 10.

### Comparative Example 4

Dyeing is performed by the method similar to Embodiment 14, and the only difference is that the dye of Comparative Example 4 has a pH value of 11.

### Comparative Example 5

Dyeing is performed by the method similar to Embodiment 14, and the only difference is that the dye of Comparative Example 4 has a pH value of 12.

After the dyed nylon fabric of Embodiments 14 to 16 and Comparative Examples 1 to 5 are obtained, the measurement of the color strength and the test of the physical properties are performed on the dyed nylon fabric of Embodiments 14 to 16 and Comparative Examples 1 to 5, and results thereof are shown in Table 5 below.

TABLE 5

| | | | | | | color |
|---|---|---|---|---|---|---|
| | | | | | | fastness |
| | | | | | | to water |
| | pH | | | | | (AATCC |
| | value | L* | a* | b* | K/S | 107) |
| Embodiment 14 | 4.5 | 46.49 | 7.81 | 17.34 | 7.11 | 4-5 |
| Embodiment 15 | 5 | 49.71 | 7.41 | 16.70 | 5.53 | 4-5 |
| Embodiment 16 | 6 | 55.82 | 7.54 | 16.61 | 3.69 | 4-5 |
| Comparative | 7 | 60.23 | 7.31 | 16.71 | 2.79 | 4-5 |
| Example 1 | | | | | | |
| Comparative | 8 | 68.93 | 3.95 | 12.32 | 1.31 | 4-5 |
| Example 2 | | | | | | |
| Comparative | 10 | 78.45 | 2.10 | 12.45 | 0.78 | 4-5 |
| Example 3 | | | | | | |
| Comparative | 11 | 80.31 | 1.08 | 10.42 | 0.67 | 4-5 |
| Example 4 | | | | | | |
| Comparative | 12 | 87.55 | −0.46 | 2.79 | 0.31 | 4-5 |
| Example 5 | | | | | | |

According to the above evaluation results, compared with Comparative Examples 1 to 5, in which dyeing is performed under a neutral or an alkaline condition (at the pH value of 7 to 12), the nylon fabric of Embodiments 14 to 16 dyed under an acidic condition (at pH value of 4.5 to 6) may not only reach the grade of 4 to 5 in the test of color fastness to water, but also present the better color strength (K/S value).

### Experimental Example 6: Dyeing the Nylon Fabric at Different Temperatures

### Embodiment 17

Dyeing is performed by a method similar to Embodiment 15, and the only difference is that a reaction temperature of Embodiment 17 is 85° C.

### Embodiment 18

Dyeing is performed by the method similar to Embodiment 15, and the only difference is that a reaction temperature of Embodiment 18 is 95° C.

### Embodiment 19

Dyeing is performed by the method similar to Embodiment 15, and the only difference is that a reaction temperature of Embodiment 19 is 115° C.

### Embodiment 20

Dyeing is performed by the method similar to Embodiment 15, and the only difference is that a reaction temperature of Embodiment 20 is 125° C.

### Comparative Example 6

Dyeing is performed by the method similar to Embodiment 15, and the only difference is that a reaction temperature of Comparative Example 6 is 75° C.

After the dyed nylon fabric of Embodiments 17 to 20 and Comparative Example 6 are obtained, the measurement of the color strength and the test of the physical properties are performed on the dyed nylon fabric of Embodiments 17 to 20 and Comparative Example 6, and results thereof are shown in Table 6 below.

TABLE 6

| | | | | | | color |
|---|---|---|---|---|---|---|
| | | | | | | fastness to |
| | reaction | | | | | water |
| | temperature | | | | | (AATCC |
| | (° C.) | L* | a* | b* | K/S | 107) |
| Embodiment 15 | 105 | 49.71 | 7.41 | 16.70 | 5.5 | 4-5 |
| Embodiment 17 | 85 | 53.2 | 6.6 | 14.9 | 3.9 | 4-5 |
| Embodiment 18 | 95 | 52.2 | 7.6 | 14.4 | 4.2 | 4-5 |
| Embodiment 19 | 115 | 48.9 | 7.0 | 14.1 | 5.1 | 4-5 |
| Embodiment 20 | 125 | 50.0 | 7.0 | 14.0 | 4.6 | 4-5 |
| Comparative | 75 | 60.9 | 4.9 | 14.9 | 2.6 | 4-5 |
| Example 6 | | | | | | |

According to the above evaluation results, compared with Comparative Example 6, in which dyeing is performed under at the reaction temperature of 75° C., the nylon fabric of Embodiments 15 and 17 to 20 dyed at the reaction temperature of 85° C. to 125° C. may not only reach the grade of 4 to 5 in the test of color fastness to water, but also present the better color strength (K/S value).

### Experimental Example 7: Dyeing the Nylon Fabric with the Dye Containing DHI and a Commercial Black Dye

### Embodiment 21

First, 5,6-dihydroxyindole (DHI) and a commercial black dye (from Oriental Giant Dyes & Chemical with the name of the dye: Bestalan Black D-R₃) are mixed to be formulated into a dye containing DHI of 50 wt %. A weight ratio of DHI to the commercial black dye is 1:1. Then, the mixed dye is added to the water to be formulated into a dye solution (in which contents of DHI and the commercial acid black dye are 5% o.w.f. each), and a pH value of the dye solution is adjusted to 5. Next, the nylon fabric is immersed in the dye solution, dyed at the reaction temperature of 105° C. and the pH value of 5 for 50 minutes, soaped at 65° C. for 15 minutes, and then washed with the clean water and dried, so as to obtain the dyed nylon fabric of Embodiment 21.

After the dyed nylon fabric of Embodiment 21 is obtained, the measurement of the color strength and the test of the physical properties are performed on the dyed nylon fabric of Embodiment 21, and results thereof are shown in Table 7 below.

TABLE 7

| | | | | | | | | color fastness |
|---|---|---|---|---|---|---|---|---|
| | | | | | color of | | | to dry |
| | | | | | the dyed | color fastness | color fastness | and wet |
| | | | | | nylon | to washing | to water | crocking |
| | L* | a* | b* | K/S | fabric | (AATCC 61) | (AATCC 107) | (AATCC 8) |
| Embodiment 21 | 12.3 | −0.7 | −2.1 | 31.5 | black | 4-5 | 4-5 | 4-5 |

According to the above evaluation results, the test of color fastness to washing, the test of color fastness to water, and the test of color fastness to dry and wet rubbing for the nylon fabric of Embodiment 21 after dyed with the mixed dye mixed with the dye (DHI) in the disclosure and the commercial black dye are all at the grade of 4 to 5, which indicates that the dye in the disclosure may be used in combination with other commercial dyes, and the dyed nylon fabric has the comprehensive properties such as good color fastness to washing, color fastness to water, and color fastness to dry and wet crocking, and conforms to industrial availability. Furthermore, under the dyeing conditions of the disclosure, the color of the nylon fabric of Embodiment 21 have the hue of black.

Based on the above, the dye in the disclosure does not use aniline as the raw material, and may be used for dyeing of the polyimide material and is conducive to the low-carbon processes. Therefore, the risk of harm to the environment and the human health may be effectively reduced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A dye for dyeing a material with amide functional groups, comprising:
a compound represented by Formula (I); and
a solvent, 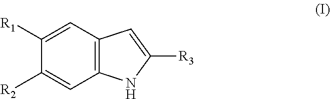
in the Formula (I), R₁, R₂ and R₃ are each independently H, —OH, or —COOH, wherein at least one of R₁, R₂ and R₃ is —OH or —COOH, and
based on a total weight of the dye of 100 wt %, a content of the compound represented by the Formula (I) is 40 wt % to 95 wt %.

2. The dye according to claim 1, wherein the compound represented by the Formula (I) is obtained by chemosynthesis or biosynthesis.

3. The dye according to claim 1, wherein the compound represented by the Formula (I) comprises 5,6-dihydroxyindole (DHI), 5,6-dihydroxyindole-2-carboxylic acid (DHICA), or a combination thereof.

4. The dye according to claim 1, wherein the material with amide functional groups comprises nylon, an artificial leather, or a combination thereof.

5. The dye according to claim 1, wherein the dye comprises 5,6-dihydroxyindole and 5,6-dihydroxyindole-2-carboxylic acid, and a weight ratio of 5,6-dihydroxyindole to 5,6-dihydroxyindole-2-carboxylic acid is 1:15 to 15:1.

6. The dye according to claim 1, wherein a hue produced by the dye is black, brown, or a mixture of the two.

7. The dye according to claim 1, wherein a pH value of the dye is 3.5 to 6.5.

8. A dyeing method, comprising using a dye solution to contact a material with amide functional groups to perform a dyeing step, wherein the dye solution comprises a dye comprising a compound represented by Formula (I), 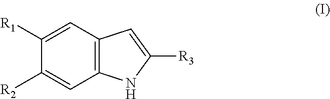
in the Formula (I), R₁, R₂ and R₃ are each independently H, —OH, or —COOH,
wherein at least one of R₁, R₂ and R₃ is —OH or —COOH, and
based on a total weight of the dye of 100 wt %, a content of the compound represented by the Formula (I) is 40 wt % to 95 wt %.

9. The dyeing method according to claim 8, wherein the compound represented by the Formula (I) comprises 5,6-dihydroxyindole (DHI), 5,6-dihydroxyindole-2-carboxylic acid (DHICA), or a combination thereof.

10. The dyeing method according to claim 8, wherein the material with amide functional groups comprises nylon, an artificial leather, or a combination thereof.

11. The dyeing method according to claim 8, wherein a concentration of the dye in the dye solution is 1% on weight of the fabric (o.w.f.) to 25% on weight of the fabric.

12. The dyeing method according to claim 8, wherein the dye comprises 5,6-dihydroxyindole and 5,6-dihydroxyindole-2-carboxylic acid, and a weight ratio of 5,6-dihydroxyindole to 5,6-dihydroxyindole-2-carboxylic acid is 1:15 to 15:1.

13. The dyeing method according to claim 8, wherein a hue of the dyed material with amide functional groups is black, brown, or a mixture of the two.

14. The dyeing method according to claim 8, wherein a reaction temperature of the dyeing step is performed at 80° C. to 130° C.

15. The dyeing method according to claim 8, wherein a reaction pH value of the dyeing step is 3.5 to 6.5.

16. The dyeing method according to claim 8, wherein a reaction time of the dyeing step is 30 minutes to 60 minutes.

17. The dyeing method according to claim 8, wherein a test of color fastness to dry and wet crocking (AATCC 8) for the dyed material with amide functional groups is at a grade of 4 to 5.

18. The dyeing method according to claim 8, wherein a test of color fastness to water(AATCC 107) for the dyed material with amide functional groups is at a grade of 4 to 5.

19. The dyeing method according to claim 8, wherein a test of color fastness to washing (AATCC 61) for the dyed material with amide functional groups is at a grade of 4 to 5.

20. The dyeing method according to claim 8, wherein the color strength (K/S) value of the dyed material with amide functional groups is 3 to 35.
